(19) United States
(12) Patent Application Publication
(10) Pub. No.: US 2012/0176796 A1
(43) Pub. Date: Jul. 12, 2012

(54) Cooling Member for Semiconductor Light Emitting Elements

(76) Inventors: Ralph Bertram, Nittendorf (DE); Zoran Bosnjak, Munchen (DE); Nicole Breidenassel, Bad Abbach (DE); Markus Hofmann, Bad Abbach (DE)

(21) Appl. No.: 13/378,667

(22) PCT Filed: May 26, 2010
(86) PCT No.: PCT/EP10/57250

§ 371 Date: Mar. 5, 2012

(30) Foreign Application Priority Data
Jun. 15, 2009 (DE) 10-2009024907.9

(51) Int. Cl. F21V 29/00; B23P 19/04; F28F 7/00

(52) U.S. Cl. 362/249.02; 165/185; 29/428

(57) ABSTRACT

A cooling member (2) for at least one semiconductor light emitting element (8), especially light emitting diode, having a mounting cavity (3) for accommodating at least part of control electronics (4) used for operating the at least one semiconductor light emitting element (8).

The invention relates to a cooling member for at least one semiconductor light emitting element, especially at least one light emitting diode, an LED lamp with such a cooling member and a method for manufacturing the lamp.

For LED lamps with high-performance light emitting diodes, in addition to cooling of the light emitting diode(s), an adequate cooling of control electronics for operating the LED lamp or its light emitting diode(s) is needed. In conventional lamps control electronics have previously been encapsulated in bitumen. LED drivers of low-power LEDs can be cooled via air bridges.

EP 1 047 903 B1 discloses an LED lamp with a column, a lamp base which is connected to one end of the column, and a substrate which is connected to the other end of the column and is provided with a number of LEDs, wherein the substrate comprises a regular polyhedron with at least four surfaces, wherein surfaces of the polyhedron are provided with at least one LED which has a luminous flux during operation of the lamp of at least 5 lm, and wherein the column is provided with heat-dissipating means which connect the substrate and the lamp base to each other.

EP 1 503 139 A2 discloses a compact LED light source which provides an LED positioning together with a heat dissipation facility. The LED light source can be manufactured with a heat-conducting plate which carries a plurality of LEDs attached to the plate and in thermal contact with the plate. The plate also carries an electrical circuit which provides an electrical connection to the LEDs. A heat conversion switching spindle carries the plate mechanically and may provide a heat conduction path away from the LEDs. LEDs can then easily be attached in a high concentration and be made available close by for an increased optical system intensity while a heat dissipation path is provided for the associated increase in the heat concentration.

The object of the present invention is to provide an especially effective, compact and simple-to-manufacture option for cooling control electronics for a lamp operating with semiconductor light emitting elements.

This object is achieved by a cooling member, a lamp and a method in accordance with the respective independent claim. Preferred forms of embodiment can especially be taken from the dependent claims.

The cooling member is provided for cooling at least one semiconductor light emitting element, especially LED, and has a mounting cavity for accommodating at least part of control electronics for operating the lamp. The cooling member of the lamp is thus used simultaneously for cooling the light emitting diodes and the control electronics.

The control electronics can thus be cooled without introducing a further component into the lamp. Savings in space and costs can be made by this method. In particular, to achieve a smaller volume, the space within cooling members which in any event is not used for convective cooling, and is not needed for heat distribution, can be used effectively. In addition the control electronics, which can come into contact with the cooling member on all sides and especially on both equipped sides in the case of circuit boards equipped on both sides, can be better cooled. This enables the service life of the electronic components of the control electronics, especially of electrolytic capacitors, to be greatly increased.

The at least one semiconductor light emitting element can feature one light emitting diode or a number of light emitting diodes. This enables comparatively low-cost and reliable light sources to be provided. In particular the at least one light emitting diode can comprise a high-power light emitting diode, with a power of 2 watts for example. A light emitting diode is to be understood as any LED unit able to be mounted on the cooling member, e.g. an LED chip, an encapsulated light emitting diode, an LED package (a housing or substrate bonded to one or more LED chips by means of bonding (wire bonding, flip-chip bonding, etc.) or an LED module (a housing or substrate connected via conventional connection methods (soldering, etc.) to one or more LED chips or LED packages) and indeed with or without optical elements.

The control electronics, especially for at least one LED, can be designed as a driver or as another control facility, e.g. based on closed-loop voltage or power control.

For especially simple installation of the control electronics, the cavity or at least one of the cooling member parts, especially each of the cooling member parts, can have a fixing means for fixing the control electronics, for example a slot for fixing a control electronics circuit board.

For especially effective cooling, achieving a small size and protection from external stresses, the control electronics can be accommodated completely in the mounting cavity.

The mounting cavity can be shaped so that material used and thereby weight is kept small. In particular the mounting cavity can also have an incandescent lamp shape as its basic shape. In particular a wall thickness of a cooling element core (cooling element without external cooling ribs) can be embodied essentially or exactly constant. As an alternative the wall thickness can be designed so that it is not less than a minimum thickness. To optimize the relationship between weight and thermal conductivity it can be preferable for the wall thickness to decrease as it gets further away from the LED.

In particular the shape of the mounting cavity and the shape of the control electronics can be matched to each other so that a prespecified distance obtains between at least one component of the control electronics and a wall of the mounting cavity. A shape of the mounting cavity adapted to the control electronics and small distances enables especially critical electronic components to be cooled more intensively because of improved thermal transfer to the cooling member.

To achieve large-surface constant spacings between the electronic components and the wall of the mounting cavity for effective cooling of the electronic components at least one wall area of the wall of the mounting cavity can be molded out plane-parallel to an opposing surface of an electronic component.

At least one area of the wall which is molded out plane-parallel to an opposing surface of the electronic component can be molded in this case onto a protrusion or a recess of the mounting cavity. This also enables critical components of different heights to be cooled effectively. Thus the wall of the mounting cavity can have at least one recess for accepting an electronic component of the control electronics, especially a transformer.

The cooling member can be designed in a number of parts, especially two parts, with at least two parts of the cooling member respectively having at least one part of a wall of the mounting cavity. The multipart nature of the cooling member makes it possible to manufacture the mounting cavity in a simple manner, enables it to be spatially well adapted to the control electronics and therefore makes possible improved cooling. In addition the control electronics and a thermal interface material can also be inserted more easily and at a more targeted location. The multipart nature of the cooling member also makes it possible to create cable breakthroughs between the individual parts, in order to reduce effort during production (threading cables through holes).

The cooling member can especially be separated along planes which lie in parallel to an axis of symmetry, especially a longitudinal axis, of the cooling member. This encloses a separation plane which accommodates the axis of symmetry. For simple manufacturing and inventory the cooling member can be designed in two parts with a mirror-symmetrical basic shape. Specifically the cooling member can be divided mirror-symmetrically along a vertical.

To improve thermal conductivity from the electronics to the cooling member and thus cooling of the electronics, the cooling member can further feature at least one thermal interface material (TIM) between at least one electronic component of the control electronics and the cooling member.

A very good price/performance ratio can be achieved by a simultaneous, targeted use of different TIM materials.

For especially good thermal conductivity a thermal interface material with a thermal conductivity of at least 5 W/(m·K), especially in the form of a thermally-conductive mat, can be introduced between an electronic component of the control electronics and the cooling member.

The lamp is equipped with one or more light emitting diodes and with at least one such cooling member, with at least part of the control electronics being accommodated in the mounting cavity.

The lamp is especially embodied as a retrofit lamp, i.e. enabling it to be used with the aid of standard bases (E12, E14, E26, E27, GU10 . . . ) as a replacement for incandescent lamps for example. The external form and the appearance are generally modeled on incandescent lamps and satisfy the standards, e.g. for the external dimensions.

The method for manufacturing such a lamp comprises at least the following steps:
at least part introduction of the control electronics into the mounting cavity;
at least part filling of the mounting cavity with at least one fluid thermal interface material;
fixing at least one semiconductor light emitting element, especially at least one light emitting diode, to the cooling member.

The step of introducing the control electronics into the mounting cavity can include the step of introducing the control electronics into a mounting cavity part of a cooling member part. Introduction into this “exposed” mounting cavity part makes especially simple manufacturing and a geometrically flexible design possible. Thus for example the control electronics does not have to be pushed into the mounting cavity but can be inserted laterally through the open side.

The step of introducing the control electronics can be preceded by a step of attaching a non-fluid (solid) thermal interface material, especially a TIM mat, to at least one component of the control electronics, especially at an area of the component which is provided for positioning in relation to a plane-parallel surface of the mounting cavity, i.e. that is preferably designed to bridge a narrow gap between the control electronics and the cooling member part. The attachment can for example be carried out by layering or gluing on the solid TIM material.

In a following step the individual cooling member parts can be assembled into the complete cooling member.

The mounting cavity of the complete (one-piece or assembled) cooling member can be filled with at least one or a further thermal interface material, especially a fluid TIM material. A “fluid material” is to be understood both as a material capable of flowing on its own and also a material capable of flowing under external influence. Gels, foams and pastes are counted among other materials as fluid materials.

By means of breakthroughs in the cooling member core between the mounting cavity and the outer side, e.g. the cable breakthrough 10, with non-separable cooling members and improved air penetration can be realized during the introduction of the fluid TIM or the TIM materials through the lower opening, since air trapped in the mounting cavity can escape through the breakthroughs.

In the figures below the invention will be explained in greater detail schematically on the basis of exemplary embodiments. In the figures elements which are the same or which function in the same way can be provided with the same reference characters for greater clarity.

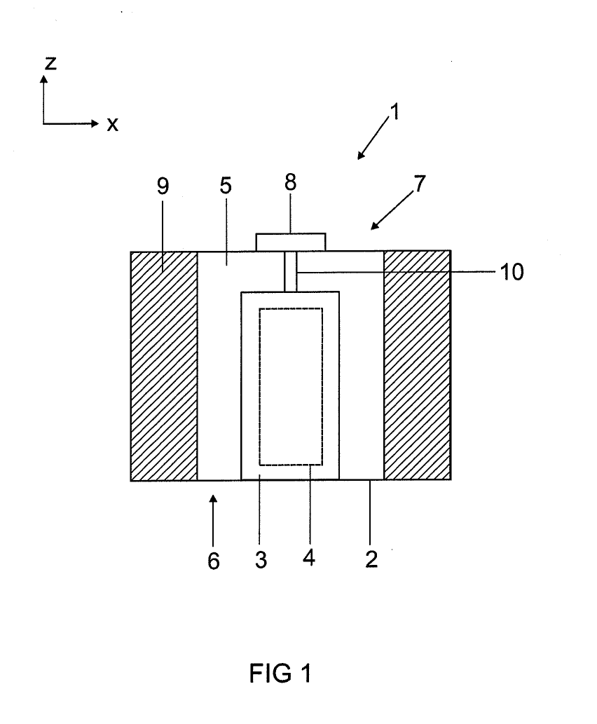

FIG. 1 shows, as a sectional diagram in a cross-sectional view, a basic sketch of an LED lamp with a cooling member which has a mounting cavity to accommodate control electronics;

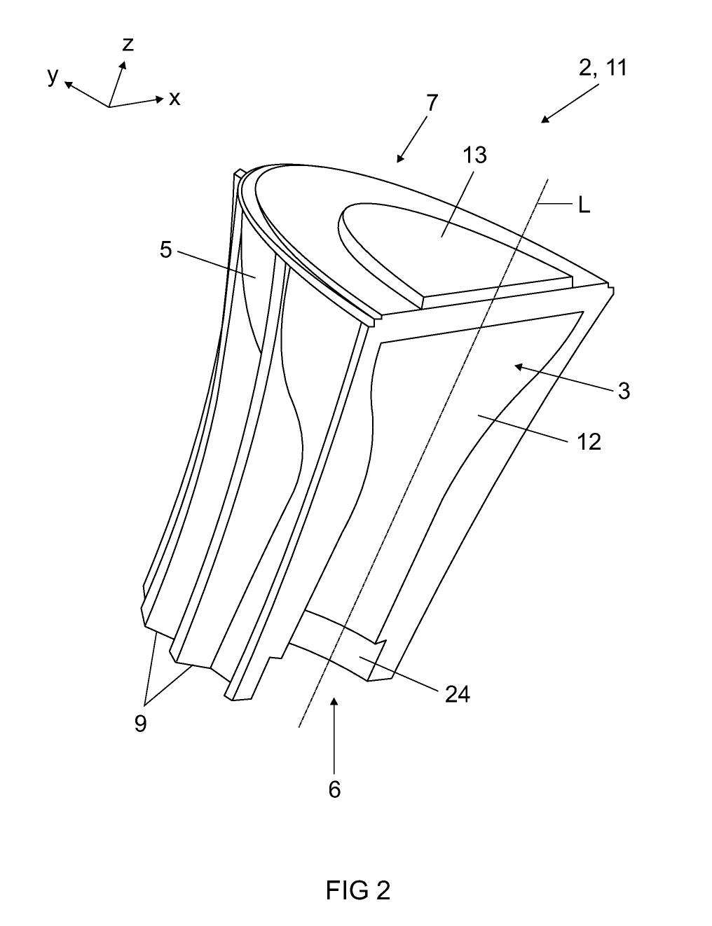

FIG. 2 shows an oblique view of a cooling member part of a cooling member of an LED lamp from FIG. 1;

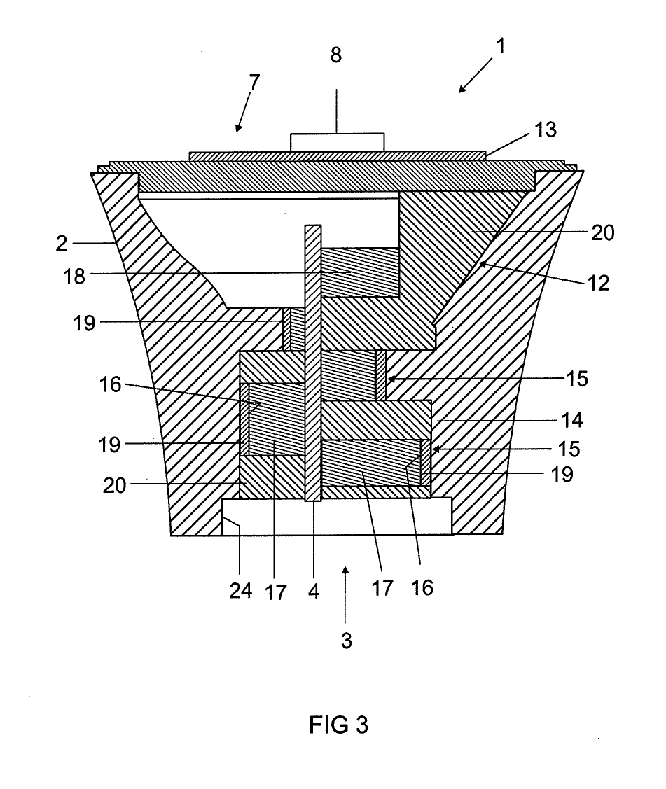

FIG. 3 shows, as a sectional diagram in a cross-sectional view, the LED lamp from FIG. 1 in greater detail with control electronics received into the cavity;

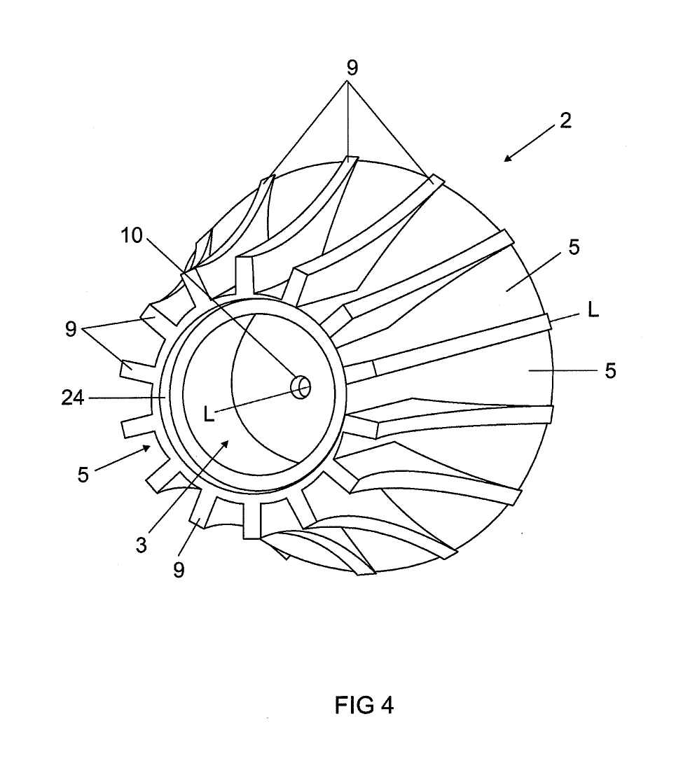

FIG. 4 shows the cooling member in an oblique view from behind;

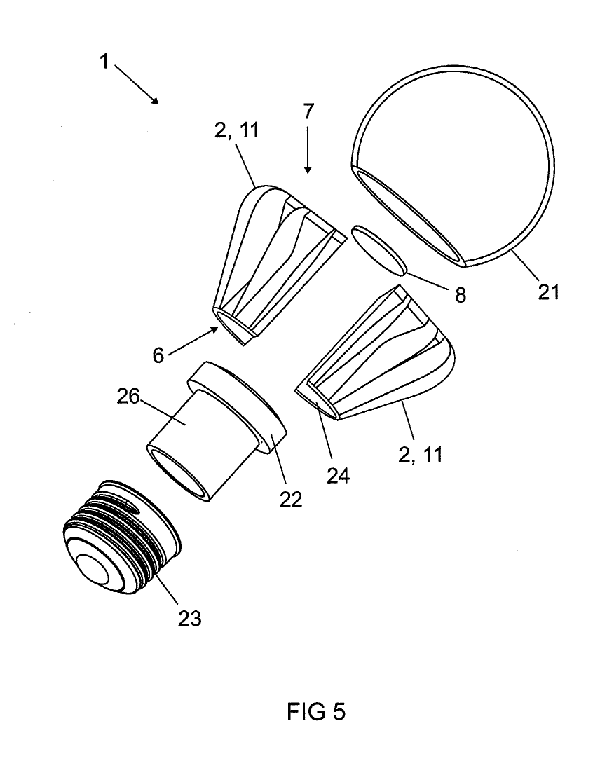

FIG. 5 shows in an oblique view as an exploded diagram, a mechanical design of an LED lamp with a cooling member in accordance with FIG. 2 to FIG. 4

FIG. 1 shows the basic construction of an LED lamp 1 with a cooling member 2 which has a mounting cavity 3 for accommodating control electronics 4. The cooling member 2 is constructed from a full-volume cooling member core 5 into which the mounting cavity 3 is made on an underside 6, while its upper side 7 is provided with a high-power light emitting diode 8 with a power of two Watts or more. Adjoining the cooling member 5 laterally are integral cooling elements in the form of vertically (aligned in the z-direction) cooling ribs 9. The light emitting diode is connected to the mounting cavity 3 via a cable breakthrough 10 running through the cooling member core 5 in order to create an installation channel for at least one electrical connection lead between the LED 8 and the control electronics 4. The cooling member 1 is assembled from two essentially mirror-symmetrical cooling member parts, as described in greater detail in FIG. 2. The sectional diagram shown in FIG. 1 can then—without the LED 8 and the control electronics—also correspond to a side view of an open side of one of the cooling member parts.

The control electronics 4 can thus be cooled without having to introduce a further component into the LED lamp 1. No more space is consumed than for a conventional cooling member 2 without mounting cavity. In addition the service life of the control electronics 4 can be greatly increased since the control electronics 4 can be in contact laterally on all sides with the cooling member 2 and can thus be better cooled. The cooling member 2 also represents a protective envelope to protect the control electronics 4 against mechanical stress and —with suitable electrically-insulating material of the cooling member or of the thermal interface material—for electrical insulation of the electronics from the environment.

During operation of the LED lamp 2 both heat, which is generated by the LED 8, and also heat which is generated by the control electronics 4, can be taken up by the cooling member core 5 and distributed to the cooling ribs 9. At the cooling ribs 9 the heat can be dissipated in the known manner by means of (free or forced) heat convention to the environment.

FIG. 2 shows an oblique view of a possible mechanical design of the cooling member 2 of the LED lamp 1 from FIG. 1 with reference to a cooling member part 11 which essentially represents half of the cooling member 2 with a section through the vertical x-z plane from FIG. 1. Both the cooling member core 5 and also the mounting cavity 3 are embodied in a straight line in the z-direction (e.g. in the form of a cylinder or cylindrical tube) but widen out from the underside 6 towards the upper side 7. Such a shape of the mounting cavity 3 is able to be achieved with a cooling member part 11 having a part of the wall 12 of the mounting cavity 3, i.e. in which the mounting cavity 3 is exposed, especially able to be reached in a simple and versatile manner. In particular there are no restrictions as regards access and processing compared to a mounting cavity only accessible from below. The cooling member part 11 shown, to complete the cooling member 2, is joined to another, essentially mirror-symmetrical cooling member part at the open surface. On its lower opening or edge the mounting cavity 3 has an extension 24 for insertion of an insulation member, as explained further below with reference to FIG. 5.

FIG. 3 shows, as a sectional diagram in a cross-sectional view, the LED lamp 1 from FIG. 1 in a greater level of detail with control electronics 4 equipped on both sides accommodated in the cavity 3. The wall 12 has flat surface sections 15 which match a closely-adjacent flat surface 16 of an electronic component 17 of the control electronics 4. In more precise terms the surface area 15 of the wall 12 lies plane-parallel to the assigned surface 16 of the closely-adjacent electronic component 17. This enables a very small, constant distance d to be achieved between the control electronics 4 or an electronic component 17 respectively and the cooling member 2. However not all electronic components need to be positioned close to the cooling member 2, but only the critical, e.g. the components 17 especially those in danger of overheating, may be arranged in this way. For other (especially non-critical) components 18 such as temperature-sensitive resistors for example, greater distances might instead be provided. To realize the small distance d for all critical components 17, the mounting cavity 3 now no longer has purely smooth walls 12 but also has protrusions 14 reaching inwards which, with a respective flat surface 15, project in the direction of an assigned flat surface 16 of an electronic component 17 and thus achieve a small distance d even with components 17 of different heights. Preferably the distance amounts to less than 1 mm, especially preferably to less than 0.5 mm.

For improved heat transmission from the control electronics 4 to the cooling member 2, the space between them is filled where possible completely with at least one thermally-conductive material 19, 20. As an alternative only the critical components 17 might for example be connected thermally via a thermally-conductive material 19 to the cooling member 2. Here the respective distance d between the critical components 17 and the wall 12 is bridged by means of inserting a thermally-conductive mat 19 with a thermal conductivity of at least 5 W/(m·K), e.g. by means of Sarcon Type GR-m or XR-e thermally-conductive pads with 6 or 11 W/(m·K) or Berquist Gap Pad 5000S35 with 5 W/(m·K). On the other hand for the remaining space and easily-fillable, especially fluid molding compound 20 with a low coefficient of thermal conductivity can be used, e.g. Berquist Gap Filler 3500S3 compound of paste/gel consistency with 3.6 W/(m·K).

If the equipping layout of the control electronics 4 is known, the cooling member 2 can thus be adapted in a simple manner to the position and geometry of the electronic components 17 to be cooled in particular. This enables an optimum cooling of the control electronics 4 to be achieved with the same time a compact construction and easy manufacturing. As an alternative or in addition, for the circuit board design of the control electronics 4 as far as possible the arrangement of the critical electronic components 17 can be tailored to the mounting cavity 3 able to be realized. In the design of mounting cavity 3 and control electronics 4, there is no need to ensure, for the divided cooling member 2 used in this embodiment, that the control electronics 4 can be pushed into the mounting cavity 3.

To manufacture an LED lamp 1, if a number (here: two) of cooling member parts 11 with corresponding proportions of the mounting cavity 3 are available, initially critical components 17 of the control electronics 4 are provided with the thermally-conductive mat 19 and the control electronics 4 is then introduced into a mounting cavity part 3 of one of the cooling member parts 11. This is especially simple with an exposed mounting cavity part 3 since it is easily accessible. For positioning and fixing the control electronics 4 fixing means not shown here can be used, such as grooves, webs, latching elements, etc. Afterwards the mounting cavity part 3 is filled with at least one fluid thermal interface material; here too the cavity can be filled especially easily. After this the cooling member parts 11 are assembled in order to form the complete cooling member 2. Then the light emitting diode 8 is fixed to the cooling member 2 and it is fixed to an LED attachment area 13. In the non-assembled state the LED attachment area 13 is also divided up between the cooling member parts 11.

FIG. 4 shows the cooling member 2 viewed at an angle from behind onto its rear side or underside 6. The cooling member 2 is essentially angle-symmetrical along its longitudinal axis L.

FIG. 5 shows a mechanical design of an LED lamp 1 with a cooling member 2 in accordance with FIG. 2 to FIG. 4, without control electronics 4, in an oblique view as an exploded diagram. This LED lamp 1 further features the LED 8 on an associated circuit board as well as a transparent protective cover 21 for the LED 8. The protective cover 21 is attached to the upper side 7 of the cooling member 2. On the underside 6 of the cooling member 2 a wider section 25 of an insulation part 22 made of plastic is pushed into the extension 24 of the mounting cavity. A lamp base 23 for power supply is covered with a narrower section 26 of the insulation part 22. The lamp-base 23 is embodied as a standard base (e.g. E12, E14, E26, E27, GU10, etc.) so that the LED lamp can be used directly as a replacement for incandescent lamps for example (also called retrofit). The external shape (e.g. a rotation symmetry around the longitudinal axis and the appearance are generally modeled on incandescent lamps and satisfy the requirements.

Naturally the present invention is not restricted to the exemplary embodiment shown.

The invention is thus also applicable to lamps with one or more low-power LEDs or also to lamps with other types of light sources such as laser diodes or compact fluorescent tubes.

The lamp can have one or more light emitting diodes. These can be present as individual diode(s) and/or as LED module(s), with an LED module being equipped with a number of LED chips on a common submount. The light emitting diodes can be single-color or multicolor. The light emitting diodes can especially be white or multicolor and produce a white mixed light. Multicolor light emitting diodes can especially be available as an RGB, RGBA, RGBW, RGBAW, etc. combination, with a luminous intensity of a color also able to be set by providing a specific number of light emitting diodes of this color. The individual light emitting diodes and/or the modules can be equipped with suitable optics for beam guidance, e.g. Fresnel lenses, collimators and so forth. Instead of or in addition to inorganic light emitting diodes based for example on InGaN or AlInGaP, organic LEDs (OLEDs) are also generally able to be used. Diode lasers can also be used for example.

Instead of protrusions on mounting cavities in the wall for control components, recesses can also pre-provided in the wall of the mounting cavity.

1. A cooling member for at least one semiconductor light emitting element, especially light emitting diode, having a mounting cavity for accommodating at least part of control electronics used for operating the at least one semiconductor light emitting element.

2. The cooling member as claimed in claim 1, wherein the control electronics is accommodated completely in the mounting cavity.

3. The cooling member as claimed in claim 1, wherein the shape of the mounting cavity and the shape of the control electronics are adapted to each other so that there is a small distance (d) between at least one electronic component of the control electronics and a wall of the mounting cavity.

4. The cooling member as claimed in claim 3, in which wherein at least one wall area of the wall is molded out plane-parallel to an opposing surface of the electronic component.

5. The cooling member as claimed in claim 4, wherein at least one wall area of the wall which is molded out plane-parallel to an opposing surface of the electronic component is molded on a protrusion or recess of the mounting cavity.

6. The cooling member as claimed in claim 1, wherein the cooling member is designed in multiple parts, with at least two parts of the cooling member each comprising a part of a wall of the mounting cavity.

7. The cooling member as claimed in claim 6, which is designed in two parts with a mirror-symmetrical basic shape of the two parts.

8. The cooling member as claimed in claim 1, further comprising at least one thermal interface material, TIM between at least one electronic component of the control electronics and the cooling member.

9. The cooling member as claimed in claim 8, wherein a thermal interface material with a thermal conductivity of at least 5 W/(m·K) is inserted between at least one electronic component of the control electronics and the cooling member.

10. A lamp with a cooling member as claimed in claim 1, with the control electronics being at least partly accommodated in the mounting cavity.

11. A method for manufacturing a lamp as claimed in claim 10, comprising the steps of:
at least part insertion of the control electronics into the mounting cavity;
at least part filling of the mounting cavity with at least one fluid thermal interface material; and
fixing at least one semiconductor light emitting element on the cooling member.

12. The method as claimed in claim 11, wherein before the step of at least partly inserting the control electronics into the mounting cavity, attaching of a nonfluid thermal interface material, to at least one component of the control electronics.

13. The cooling member as claimed in claim 8, wherein a thermally-conductive mat with a thermal conductivity of at least 5 W/(m·K) is inserted between at least one electronic component of the control electronics and the cooling member.

14. The method as claimed in claim 11, wherein, before the step of at least partly inserting the control electronics into the mounting cavity, attaching a TIM mat to at least one component of the control electronics.
